(19) United States
(12) Patent Application Publication
(10) Pub. No.: US 2017/0057119 A1
(43) Pub. Date: Mar. 2, 2017

(54) AUTOMATED PRESS CELL SYSTEM AND METHODS OF USING THE SAME FOR FORMING COMPOSITE MATERIALS

(71) Applicant: Triumph Integrated Aircraft Interiors, Inc., Wayne, PA (US)

(72) Inventors: Nicolas Michael Agostinelli, Cheney, WA (US); Nicholas Steven Busch, Spokane, WA (US)

(21) Appl. No.: 14/836,211

(22) Filed: Aug. 26, 2015

(51) Int. Cl. B29B 11/12

(52) U.S. Cl. CPC B29B 11/12; B29K 2081/04

(57) ABSTRACT

An automated system and method are provided for forming composite materials.

### FIELD OF THE INVENTION

The present invention relates generally to a system and method for forming polymeric materials and more particularly, but not exclusively, to an automated system and method for forming reinforced thermoplastic laminate (RTL) materials.

### BACKGROUND OF THE INVENTION

A variety of industries, such as the aerospace industry, use reinforced thermoplastic laminate (RTL) materials. For example, sheets of RTL materials may be cut and press formed to manufacture aircraft components.

The present invention meets a need in the field by providing an automated press cell system and method that can more efficiently fabricate and form composite materials.

### SUMMARY OF THE INVENTION

The present invention includes an automated press cell system and method for producing formed polymeric materials and composite materials.

In one aspect, the present invention includes an automated system for forming a polymeric blank. The system may include an automated forming cell or a plurality of automated forming cells.

The automated forming cell may include a receiver station that may be configured to admit the polymeric blank into the forming cell. The receiver stations of the invention may include operator turn table stations (i.e., load/unload stations) that allow an operator to load an opposing station to reduce down time after a first station is loaded. The automated forming cell may include at least two oven banks that may receive the polymeric blank from the receiver station. The at least two oven banks may include a plurality of ovens that may be configured to heat the polymeric blank to a working temperature. The automated forming cell may include a mechanical press that may receive the heated polymeric blank from the at least two oven banks and press the polymeric blank into a form. The automated forming cell may also include at least two transfer robots that may be disposed within the forming cell. The at least two transfer robots may be configured to transfer the polymeric blank between two or more of the group consisting of the receiver station, the at least two oven banks, and the mechanical press.

The automated system of the invention may include a control system that may be communicatively coupled to the automated forming cell. The control system may be configured to operate one or more of the group consisting of the receiver station, the at least two oven banks, the mechanical press, and the at least two transfer robots.

In another aspect, the invention may include an automated method for forming a polymeric blank into a formed polymeric material with a system of the invention. The method may include receiving the polymeric blank at a receiver station of an automated forming cell. The method may also include robotically transferring the polymeric blank from the receiver station to one of at least two oven banks and heating the polymeric blank to a working temperature. Moreover, the method may include robotically transferring the heated polymeric blank to a mechanical press and pressing the heated polymeric blank into a formed polymeric material. Additionally, the method of the invention may include robotically transferring the formed polymeric material to the receiver station of the automated forming cell.

The methods and systems of the invention provide an advantage in the field by allowing for the simultaneous pre-heating of at least four composite polymeric materials. As a result, the systems and methods of the invention maximize the use of a connected mechanical press in the automated press cell. Preferably, the press cells of the invention may include about four ovens to a single mechanical press in order to maximize cell throughput.

### BRIEF DESCRIPTION OF THE DRAWINGS

The foregoing summary and the following detailed description of the exemplary embodiments of the present invention may be further understood when read in conjunction with the appended drawings, in which:

FIG. 1 schematically illustrates an automated system 1 of the invention.

FIG. 2 schematically illustrates an exemplary automated system 2 of the invention.

FIG. 3 schematically illustrates an exemplary automated system 3 that includes a plurality of automated cells.

FIG. 4 schematically illustrates an automated method 10000 of the invention.

FIG. 5 diagrammatically illustrates an exemplary automated method of the invention and provides the timing for each step of the method. RS 1=Receiver Station 1, RS 2=Receiver Station 2, TR 1=Transport Robot 1, TR 2=Transfer Robot 2, OB 1/O 1=Oven 1 in Oven Bank 1, OB 2/O 2=Oven 2 in Oven Bank 2, OB 1/O 3=Oven 3 in Oven Bank 1, and OB 2/O 4=Oven 4 in Oven Bank 2.

### DETAILED DESCRIPTION OF THE INVENTION

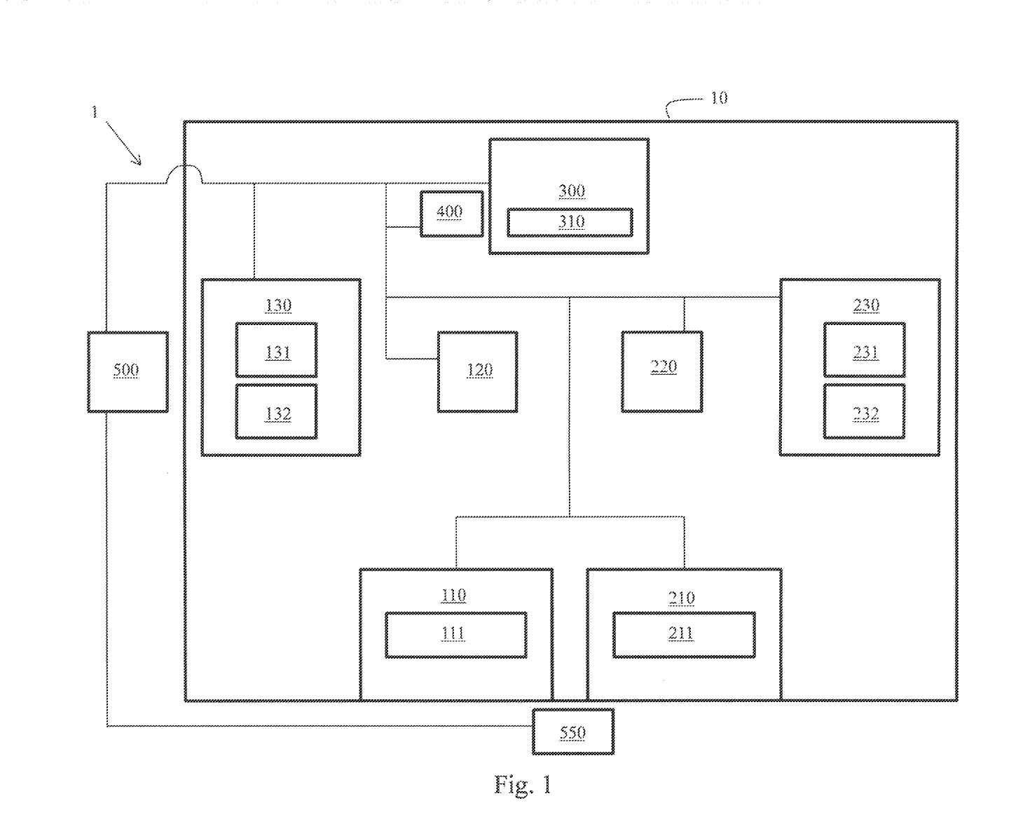

Referring now to the figures, wherein like elements are numbered alike throughout, FIG. 1 provides an automated forming system 1. The automated forming system 1 of the invention allows for the manufacturing of monolithic parts that include a thermoplastic material. For example, the present invention includes automated systems and methods for forming a polymeric blank that may include a thermoplastic material.

The polymeric blanks formed according to the invention may include a polymeric material selected from the group consisting of polyphenylene sulfide (PPS), polyether imide (PEI), polyetheretherketone (PEEK), polyetherketoneketone (PEKK), and combinations thereof. The polymeric blanks may also comprise a fibrous material selected from the group consisting of Kevlar, carbon fiber, fiberglass, and a combination thereof.

In certain embodiments, the polymeric blank comprises a reinforced thermoplastic laminate (RTL) material. The RTL material may include a weaved fabric, a UD tape, a chop fiber, or a combination thereof. In addition, the polymeric blank may include a reinforced thermoplastic non-laminated material such as, for example, a weaved fabric, a UD tape, a chop fiber, or a combination thereof. In a preferred aspect, the polymeric blank comprises an RTL material that includes a polymeric material, as described herein.

The automated forming system 1 may include an automated press cell (APC) 10. Each APC 10 may include a station for loading and unloading parts, oven bank stations for heating the parts before forming, a mechanical press station, and one or more robots for transferring the parts to be worked from one station to another.

APC 10 includes receiver stations 110 and 210, oven banks 130 and 230, and mechanical press 300. Moreover, APC 10 includes two sets of robots. As used herein, the term “robot” may refer generally to any form of mobile electro-mechanical device that can be controlled by a computer system (e.g., control system 500) with associated computer programming that embodies a robotic method and instructions. For example, APC 10 may include transfer robots 120 and 220 and a mold release robot 400.

In addition, the various components of the APC 10 may be communicatively coupled to a control system 500, which is provided to control and monitor the various components of the APC 10.

Regarding the components of the invention, APC 10 may include a receiver station such as receiver stations 110 and 210. Specifically, APC 10 includes a first receiver station 110 and a second receiver station 210. The receiver stations may include a table or loading platform upon which a user can place a polymeric blank for retrieval by one of the transfer robots 120 or 220. The first and second receiver stations 110 and 210 may include first and second loading/unloading platforms 111 and 211, respectively. The first and second loading/unloading platforms 111 and 211 may include a rotatable platform having two opposing loading/unloading stations. The opposing loading/unloading stations (e.g., station A and station B) may be placed on either side of the rotatable platform. The stations may be separated by a wall that stands in the middle of the rotatable platform to shield the user from the interior of the APC 10.

For example, during operation of the APC 10, a user may address a receiver station 110 (or 210) and place a polymeric blank on loading/unloading station A of the loading/unloading platform 111 (or 211). Upon a command from the user, the loading/unloading platform 111 (or 211) may be rotated 180° to (1) allow a transfer robot (i.e., transfer robot 120 or 220) to retrieve the polymeric blank placed at loading/unloading station A; and (2) present loading/unloading station B to the user so that the user may place another polymeric blank on loading/unloading station B. After the polymeric blank is retrieved from loading/unloading station A by a transfer robot (i.e., transfer robot 120 or 220), the loading/unloading platform 111 (or 211) may again be rotated 180° to allow a transfer robot (i.e., transfer robot 120 or 220) to retrieve the polymeric blank placed at loading/unloading station B; and (2) present loading/unloading station A to the user so that the user may place another polymeric blank on loading/unloading station A or, alternatively, retrieve a formed polymeric material from loading/unloading station A. Indeed, after a polymeric material has been pressed by the mechanical press 300, as described herein, a transfer robot may return the formed polymeric material to the first or second loading/unloading platform 111 or 211 at a loading/unloading station for retrieval by the user. Additionally, when two receiver stations (110 and 210) are used, a user may engage the start cycle for the system 1 and begin loading a polymeric blank at the second receiver station 210 after a polymeric blank has been loaded at the first receiver station 110.

Each of the loading/unloading stations of the invention may also include a mount for holding a shuttle tray carrier. The shuttle tray may be configured to hold and support a polymeric blank placed thereon during the heating process and during pressing so that the transfer robots (i.e., transfer robots 120 and 130) need only grip the shuttle tray. Each loading/unloading station described herein may include indexing and poke-yoke features (e.g., alignment marks, pegs, slots, grooves, etc.) that ensure that the shuttle tray cannot be loaded incorrectly by a user. For example, the indexing and poke-yoke features will prevent a user from loading a shuttle tray on the loading/unloading station in a manner that would prevent one of the transfer robots from successfully gripping and retrieving the shuttle tray from the mount. Accordingly, in preferred aspects of the invention, the APC 10 will include two receiver stations (i.e., receiver stations 110 and 210) with each receiver station having a loading/unloading platform (e.g., platforms 111 and 211), where each loading/unloading platform has two loading/unloading stations.

However, a person having ordinary skill in the art would appreciate that the APC 10 could have one or more receiver stations that may include one or more loading/unloading platforms (e.g., two loading/loading platforms at one receiver station). Additionally, a person having ordinary skill in the art would appreciate that each loading/unloading platform described herein may have two or more loading/unloading stations (e.g., three loading/unloading stations). Furthermore, although preferred embodiments of the invention describe the receiver stations as locations for both loading of polymeric blanks and unloading of formed polymeric materials, it is also within the scope of this invention to have a receiver station for loading polymeric blanks and a separate unloading station in the APC 10 where formed polymeric materials may be deposited for retrieval by a user.

In addition, the shuttle trays used by the systems of the invention may include an outer frame that may be common to every shuttle tray. The outer shuttle tray frame may have index locations as well as a common interface to the End of Arm Tooling (EOAT) on the first and second transfer robots 120 and 220. These index locations will be consistent between the part loading/unloading stations and the oven banks. Preferably, there will be no indexing locations at the mechanical press as one of the transfer robots may hold the shuttle tray while the polymeric blank is being formed by the mechanical press.

The first and second receiver stations 110 and 210 may include a scanner (e.g., a handheld barcode reader) for scanning a representative code on the shuttle tray and/or the polymeric blank and providing representative information (e.g., the ID of the shuttle tray and the polymeric blank) to the control system 500. In conjunction with the scanner, each of the first and second receiver stations 110 and 210 may include a label printer for printing identification labels that may be affixed to a completed, formed polymeric material.

The first and second receiver stations 110 and 210 may also include a door, such as a sliding door, that may open and close to allow a user access to the first and second loading/unloading platforms 111 and 211.

The APC 10 may also include first and second transfer robots 120 and 220. Each of the first and second transfer robots 120 and 220 may be six-axis robots that include a moveable robotic arm having End of Arm Tooling (EOAT) for indexing and gripping the shuttle trays described herein. Moreover, the first and second transfer robots 120 and 220 may be communicatively coupled to the control system 500.

The first transfer robot 120 may be configured or programmed through the control system 500 to perform the tasks of: (1) retrieving a polymeric blank from the first receiver station 110 and placing it in an oven of the first oven bank 130; (2) transferring the heated polymeric blank from an oven of the first oven bank 130 to the mechanical press 300 and holding the heated polymeric blank during pressing; (3) transferring the formed polymeric material from the mechanical press 300 to the receiver station 110 for retrieval; and (4) indexing a code on the shuttle tray holding the polymeric material at the receiver station 110 and/or the oven bank 130 to ensure that it is transferring the correct shuttle tray. The second transfer robot 220 may be configured or programmed through the control system 500 to perform the tasks of: (1) retrieving a polymeric blank from the second receiver station 210 and placing it in an oven of the second oven bank 230; (2) transferring the heated polymeric blank from an oven of the second oven bank 230 to the mechanical press 300 and holding the heated polymeric blank during pressing; (3) transferring the formed polymeric material from the mechanical press 300 to the receiver station 210 for retrieval; and (4) indexing a code on the shuttle tray holding the polymeric material at the receiver station 210 and/or the oven bank 230 to ensure that it is transferring the correct shuttle tray. Each of the first and second transfer robots 120 and 220 may also be configured or programmed to position the shuttle tray on a forming die that is disposed within the mechanical press 300 to adjust the shape and parameters of the resulting formed polymeric material.

The first and second transfer robots 120 and 220 may include one or more IR cameras (e.g., one camera per robot) that may be used to detect the presence of a polymeric blank on the robot. Each transfer robot 120 and 220 may also include a proximity sensor (e.g., proximity switch) for determining the current position of the robot in the APC 10.

Preferably, each of the transfer robots (i.e., robots 120 and 220) is a Kuka KR150 robot, which may be used for material transferring.

The APC 10 may also include first and second oven banks 130 and 230. The oven banks may receive the polymeric blanks from the receiver stations 110 and 210, respectively, and heat the polymeric blanks to a working temperature. In certain aspects, each oven bank 130 and 230 may include a plurality of ovens. Preferably, each oven bank 130 and 230 includes a first oven 131,231 and a second oven 132,232. Therefore, in certain embodiments of the invention, the first and second oven banks 130 and 230 each include two ovens for a total of four ovens located at in the APC 10.

The first ovens 131,231 and second ovens 132,232 may be stacked or they may be arranged in a side-by-side configuration. Preferably, the first ovens 131,231 and second ovens 132,232 are arranged in a stacked configuration in each of the first and second oven banks 130 and 230. The ovens in each of the oven banks 130 and 230 may be supported by an oven stand. Each of the ovens of the invention may include a heat source. Preferably, the heat source for each oven is an IR heat source such as a quartz IR heater. The ovens of the invention may have a maximum temperature of 550° C.

A preferred oven of the invention may be able to heat certain polymeric blanks to their working temperatures within about 150 to 330 seconds. The preferred polymeric materials of the invention have varied working temperatures and, therefore, the ovens included within the APC 10 may be configured to provide such temperatures on demand within about 150 to 330 seconds. For example, PEKK may have a working temperature of about 335 to 435° C.; PEI may have a working temperature of about 310 to 410° C.; PPS may have a working temperature of about 280° C. to 380° C.; and PEEK may have a working temperature of about 375° C. to 475° C.

Additionally, each oven of the invention may include one or more temperature sensors that are communicatively coupled to the control system 500. Indeed, the ovens of the invention may include an optical pyrometer that may measure the working temperature for each of the polymeric blanks deposited therein. The ovens of the invention may also include a thermocouple that measures the temperature within the oven itself.

Furthermore, each oven of the invention may be controlled through the control system 500 to adjust the temperature of the ovens based on the composition of the polymeric blank. For instance, each oven may communicate with the control system 500 to receive a part recipe and report the heat-up profile for the oven and polymeric blank. Temperature monitoring at the oven may also allow for calibration and certification of each oven. The ovens of the invention may also be enclosed with walls and insulation, as would be understood by a person having ordinary skill in the art. Each oven may be configured to hold one shuttle tray at a time.

The APC 10 may also include a mechanical press 300. The mechanical press 300 may be a down acting press that may receive a heated polymeric blank on a shuttle tray and press the heated polymeric material into a die 310 that is locked into the mechanical press 300. The mechanical press 300 may provide a working part pressure on the heated polymeric blank of about 5 bar to 100 bar. Preferably, the working part pressure may be about 10 to 60 bar. For example, the working part pressure may be about 30 bar or about 40 bar.

In one embodiment, the mechanical press may be a four post, down acting hydraulic press. In certain exemplary embodiments of the invention, the mechanical press may provide a downward pressure of about 100 tons. Moreover, in particular aspects, the mechanical press 300 may be a hydraulic press having a hydraulic pressure system configured to recover within about 5 to 10 seconds. The mechanical press 300 may also include a pressure transducer that may measure the pressure that is being received by the heated polymeric blank via the head pressure on a hydraulic cylinder, for example. The pressure transducer and mechanical press 300 may be communicatively coupled to the control system 500. The mechanical press may include a non-heated platen.

The die 310 may be part of an interchangeable die set that can be switched out, as necessary, from the mechanical press 300 depending upon the part to be formed. The die 310 may also include a die heating system. For example, each forming die of the invention may include a portion that is heated using imbedded cartridge heaters controlled by an attached thermocouple that is communicatively coupled to the control system 500. Additionally, the die 310 may include a thermocouple that measures the temperature of the forming dies located at the mechanical press 300.

The APC 10 may also include a forming die mold release application system. The forming die mold release application system may include a sprayer positioned next to the mechanical press that applies a selected mold releasing agent to the die 310 after certain press cycles to ensure that the formed polymeric material releases from the die 310. The mold release system may be fed from a single reservoir that is monitored by the control system 500 and includes a fluid level sensor. The forming die mold release application system may be a mold release robot 400. Preferably, the mold release robot is a Kuka KR6 robot having an EOAT that is designed with a mold release spray atomizing nozzle in fluid communication with a mold release reservoir and pump.

The automated system 1 may also include a control system 500 that may be communicatively coupled to the APC 10 and, more particularly, the first and second receiver stations 110 and 210, the first and second transfer robots 120 and 220, the first and second oven banks 130 and 230, the mechanical press 300, and the forming die mold release application system 400. The control system 500 is provided to monitor the various components of the APC 10, provide commands or instructions to the various components of the APC 10, and record data associated with the forming processes of the system 1.

The terms “communication” and “communicatively coupled” are defined herein, unless more specifically indicated (e.g, fluidic communication, mechanical communication), as a general state in which two or more components of the systems of the invention (e.g., the APC 10 and the control system 500) are connected such that communication signals (i.e., analog or digital signals) are able to be exchanged (directly or indirectly) between the components on a unidirectional or bidirectional (or multi-directional) manner, either wirelessly, through a wired connection, or a combination of both as would be understood by a person having ordinary skill in the art.

The control system 500 may include a processor, one or more transceivers or ports for communicating with connected components and sensors, and a user interface 550. The term “processor” as used herein is a broad term and, unless more specifically indicated, is to be given its ordinary and customary meaning to a person of ordinary skill in the art, and furthermore refers without limitation to a computer system, state machine, and the like that performs arithmetic and logic operations using logic circuitry that response to and process the basic instructions that drive a computer. The control system 500 of the invention may also include data storage devices that include non-transitory media, such as floppy disks and diskettes, compact disk (CD)-ROMs (whether or not writeable), DVD digital disks, RAM and ROM memories, computer hard drives and back-up drives, external hard drives, “thumb” drives, and any other storage medium readable by a computer for the storage of electronic data, in any form, as described herein.

The user interface 550 of computer system 500 may include at least one of textual, graphical, audio, video, animation, and/or haptic elements. A textual element may be provided, for example, by a printer, monitor, display, projector, etc. A graphical element may be provided, for example, through a monitor, display, projector, and/or visual indication device, such as a light, flag, beacon, etc. An audio element may be provided, for example, through a speaker, microphone, and/or other sound generating and/or receiving device. A video element or animation element may be provided, for example, through a monitor, display, projector, and/or other visual device. A haptic element may be provided, for example, via, a very low frequency speaker, vibrator, tactile stimulator, tactile pad, simulator, keyboard, keypad, mouse, trackball, joystick, gamepad, wheel, touchpad, touch panel, pointing device, and/or other haptic device, etc.

The user interface 550 may include a part scanner (e.g., bar code scanner, and the like) that may be used to scan a code associated with a polymeric blank to be subject to a forming operation and download or otherwise retrieve forming information and instructions from a look up table stored at the control system 500 or on a remote server. For example, the forming information may include part parameters, heating instructions (e.g., working temperatures and times), mechanical pressures to be applied at the press, the type of die to use to produce a specific formed part, a timing protocol for the transfer robots, or other requirements necessary to provide a forming operation for a specific polymeric blank. Accordingly, a user of the invention may indicate at the user interface 550 the type of part to be formed from a polymeric blank and the control system 500 may provide the appropriate instructions to the APC 10 related to the indicated part. Such instructions may be retrieved from a pre-programmed look up table in the control system 500.

In a preferred embodiment, the system 1 may include a user interface 550 located proximate to the receiver stations 110 and 210. The user interface 550 may be the main control interface for the system 1. The user interface 550 may provide a number of menus that allow the user to input, modify, and/or view process recipes, perform manual manipulation of the automated press cell hardware at the control system 500, view and clear error codes, display system information (e.g., what forming die, shuttle tray, polymeric blank number is loaded in the APC 10), and access any technical information (e.g., manuals, work instructions).

Additionally, the APC 10 may include one or more sensors located at various components that may sense a selected parameter (e.g., temperature, proximity, contact, etc.) and convert the parameter to a digital or analog signal, which may then be transmitted to a communicatively coupled computer such as control system 500. Data representing the sensed selected parameters for each sensor may then be displayed at the user interface 550. For example, the first and second receiver stations 110 and 210, the first and second oven banks 130 and 230, and the mechanical press 300, may include proximity sensors communicatively coupled to the control system 500. The proximity sensors (i.e., proximity switches) may be used to locate and detect the presence of the shuttle tray, the polymeric blank, and/or another component of the system (e.g., a transfer robot 120 or 220) that is proximate to the respective proximity sensor. Indeed, the proximity sensor may be used, for example, to indicate when one of the first and second receiver stations 110 and 210 have loaded or unloaded platforms 111 and 211. Based on this information, a user at the user interface 550 may know which of the first and second receiver stations 110 and 210 may be loaded next with a polymeric blank. The components of APC 10 may also include one or more pyrometers, thermocouples, pressure transducers, and IR cameras.

It is noted that various sensor values and alarm values that may be produced by the sensors or control system of the invention represent actual physical conditions of different places and/or different equipment and/or different parts of a component or vessel or other place, e.g., generally local conditions, that are transformed by the system and method described herein to provide a representation of the overall state and/or condition of the component, vessel, or place, e.g. a representation of the complete component, vessel, and/or place. That representation may be transformative of a representation of a nominal overall state and/or condition thereof, e.g., in a prior or different condition and/or time, to a representation of an actual overall state and/or condition thereof, e.g., in a present or more recent or otherwise different condition and/or time.

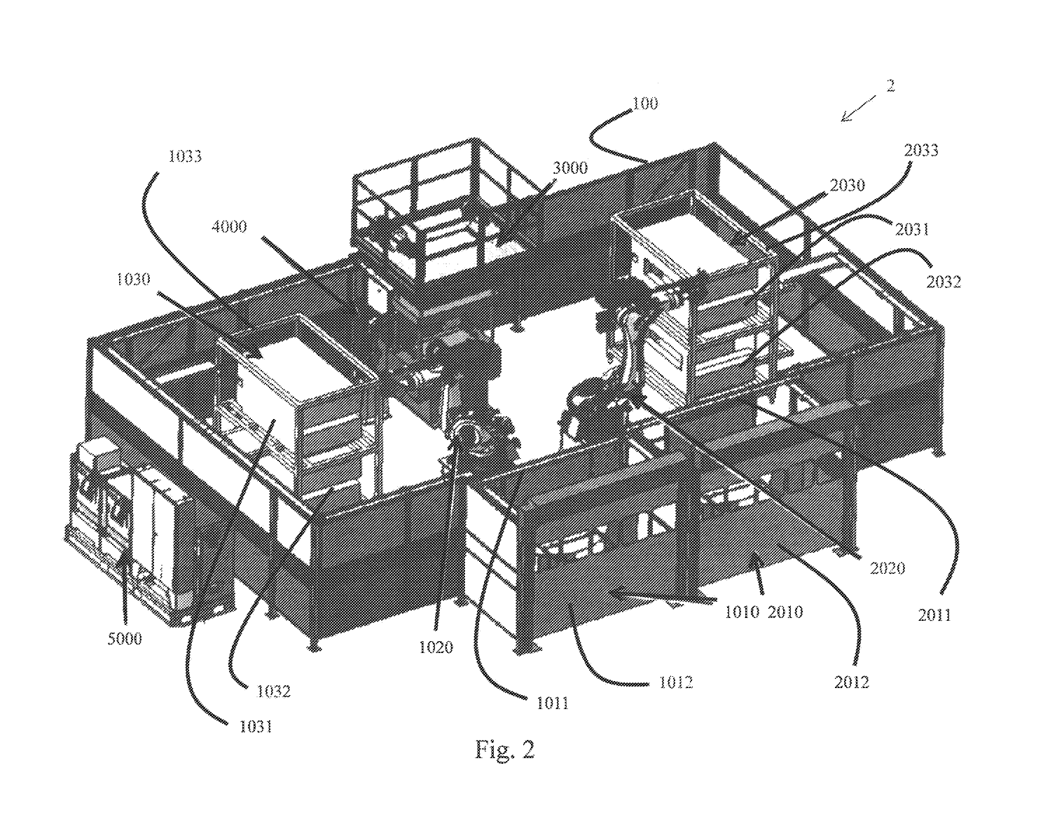

FIG. 2 provides an exemplary automated forming system 2. Automated forming system 2 includes an APC 100 and a control system 5000.

The APC 100 includes a first receiver station 1010 and second receiver station 2010. The first and second receiver stations 1010 and 2010 include first and second loading/unloading platforms 1011 and 2011 that are configured to rotate. Each of the first and second loading/unloading platforms 1011 and 2011 include two opposing loading/unloading stations, separated by a divider, and also include mounts for holding a shuttle tray. Furthermore, the first and second receiver stations 1010 and 2010 include first and second sliding doors 1012 and 2012.

The APC 100 also includes first and second transfer robots 1020 and 2020 that are Kuka KR150 robots that have EOAT for indexing and gripping shuttle trays. Moreover, the APC 100 includes first and second oven banks 1030 and 2030. Each of the first and second oven banks 1030 and 2030 include first ovens 1031,2031 and second ovens 1032,2032, which are stacked in oven stands 1033 and 2033, respectively.

The APC 100 also includes a hydraulic mechanical press 3000 that is configured to provide 100 tons of pressure and includes an interchangeable forming die. In addition to the press 3000, the APC 100 includes a mold release applicator robot 4000 that is a Kuka KR6 robot with an EOAT designed with a mold release spray atomizing nozzle.

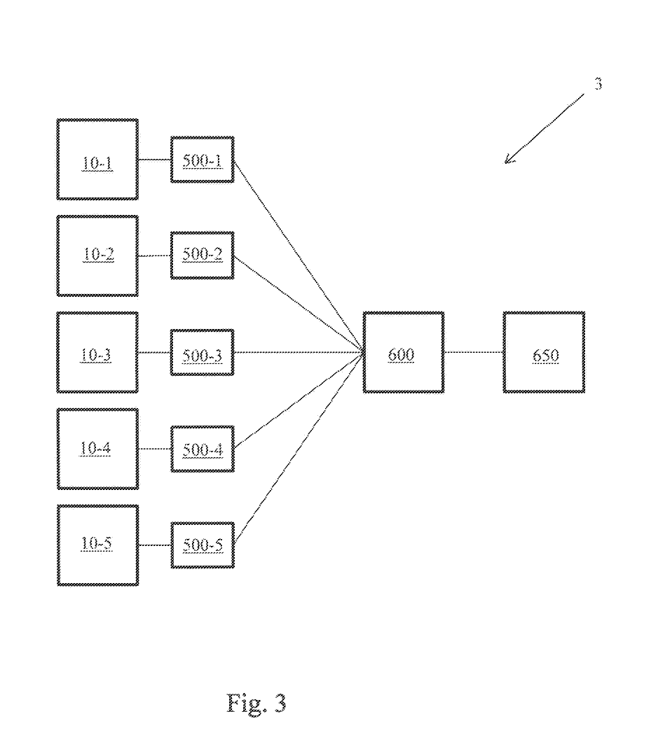

FIG. 3 provides an exemplary embodiment of the invention and includes a automated processing array 3 that includes a plurality of APCs connected to a master control for processing a plurality of polymeric blanks simultaneously. The automated processing array may include a number of APCs, which are listed as APCs 10-1 to 10-5 in FIG. 3. Moreover, each of the APCs 10-1 to 10-5 may be communicatively coupled to local control systems 500-1 to 500-5, which s programmed to locally control each APC in array 3. Each of the local control systems 500-1 to 500-5 is connected to master control system 600, which may include one or more processors, data storage systems, and transceivers necessary for communicating with the local control systems 500-1 to 500-5. The master control 600 may then be communicatively coupled to a master user interface 650. Master user interface 650 may be a local user interface having a display at the master control system 600, a remote user interface that communicates with the master control system 600 via the internet, or a combination thereof.

The present invention includes an automated method for forming a polymeric blank into a formed polymeric material with an automated press system as described herein. Preferably, the methods of the invention may be performed with one of systems 1, 2, or 3.

With reference to system 1, the methods of the invention may generally include the steps of:
1. Receiving or loading a polymeric blank at a receiver station of an APC.
2. Robotically transferring the polymeric blank from the receiver station to an oven bank (i.e., one of the two oven banks present in the APC). As used herein, the term “robotically transferring” may refer to the transfer of an object (e.g., a polymeric blank/shuttle tray) with the aid of a robot.
3. Heating the polymeric blank to a working temperature.
4. Robotically transferring the heated polymeric blank from the oven bank to a mechanical press.
5. Pressing the heated polymeric blank into a formed polymeric material.
6. Robotically transferring the formed polymeric material from the mechanical press to the receiver station.
7. Unloading the formed polymeric material from the receiver station.

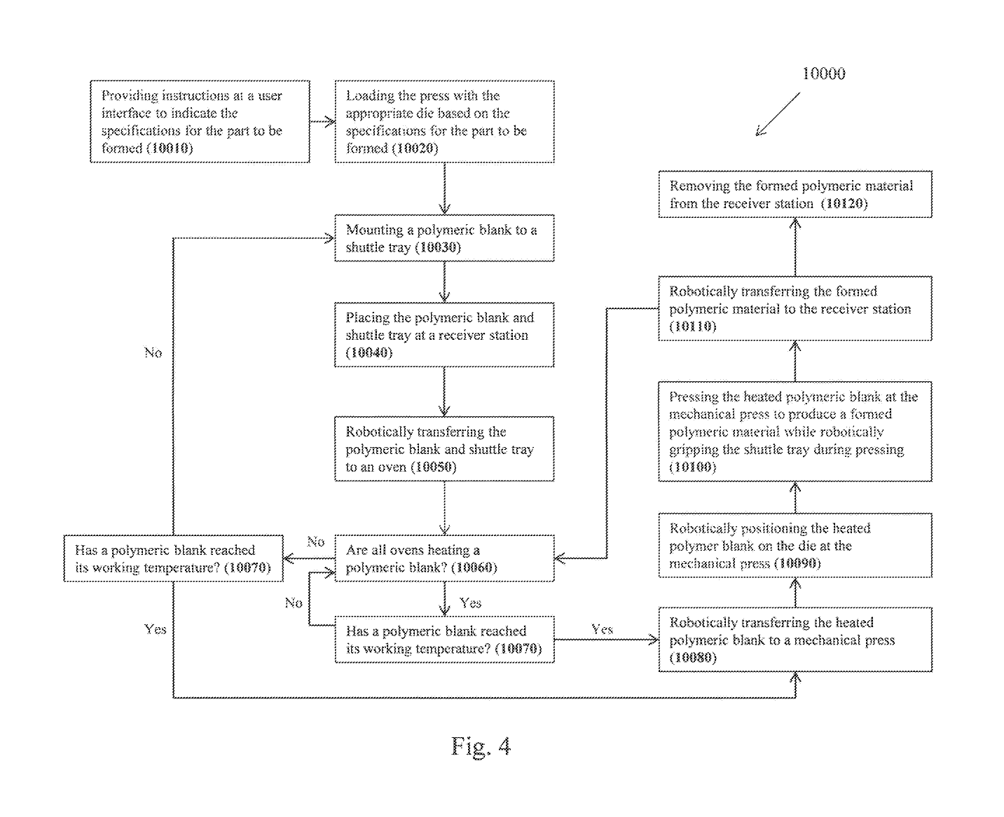

FIG. 4 provides exemplary method 10000 of the invention that utilizes system 1.

The method of the invention may include first scanning or inputting a part number into the system 1 at a user interface by a user to indicate to the system the type of part to be formed. As provided in step 10010, this may include providing instructions or a part specification at the user interface that are relative to the part being formed. For example, such instructions may include oven temperature, heating times, the identity of the polymeric material of the part, batch number, holding pressure at the mechanical press, transfer times from the oven bank to the mechanical press, and the type of die to be used at the mechanical press.

The method may further include loading the mechanical press with the appropriate die based on the specifications for the part to be formed (step 10020). Indeed, a variety of different parts may be formed by the systems of the invention and each specific part may require a different die or set of dies. Accordingly, the dies of the invention may include an interchangeable die set that may be changed based on the part, as would be understood by a person having ordinary skill in the art.

After preparing the system 1 at steps 10010 and 10020, the method may include mounting a polymeric blank to a shuttle tray (step 10030) and placing the polymeric blank and shuttle tray at a receiver station (step 10040).

Once at the receiver station, a robot may retrieve the shuttle tray and place the shuttle tray in an oven, which may be in an oven bank (step 10050). The ovens used in the methods of the invention may heat a polymeric blank to a working temperature. The working temperature may be a specific temperature or temperature band at which the polymeric blank may be removed and worked by a mechanical press within a certain period of time. The working temperature may vary depending upon the composition of the polymeric blank. Retrieving the shuttle tray may also include indexing the shuttle tray by the robot to examine the identity of the polymeric blank on the shuttle tray. This indexing procedure may ensure that the polymeric material at the shuttle tray matches the heating program to be run. Moreover, the robot may determine, with the aid of an IR camera, whether the polymeric material is still present on the shuttle tray or if it has fallen off during transfer. Upon depositing the shuttle tray at the oven, the robots may return to a home or resting position.

Regarding working temperatures more specifically, the working temperatures for certain polymeric materials of the invention may be about 150° C. to about 550° C. In other embodiments, the working temperature may be about 300° C. to about 450° C. For example, a PEKK blank may have a working temperature of about 335° C. to about 435° C. A PEI blank may have a working temperature of about 310° C. to about 410° C. A PPS blank may have a working temperature of about 280° C. to about 380° C. A PEEK blank may have a working temperature of about 375° C. to about 475° C.

The ovens of the invention may be adapted to heat the polymeric blank to a working temperature for that blank within a predetermined heating time. In certain instances, the heating time may be about 150 to 330 seconds. Preferably, the heating time is about 240 seconds. The ovens of the invention may heat the polymeric blank using any heating method known the art for heating polymeric compositions. However, in preferred aspects, the ovens of the invention are quartz infrared ovens (IR).

After a polymeric blank is placed in an oven for heating, the method may then include determining if all of the ovens are presently heating a polymeric blank (step 10060). The APC 10 of system 1 includes at least four ovens that divided equally between two oven banks 130 and 230. Therefore, each of the four ovens may heat a polymeric blank at any given time. Accordingly, if one oven is heating a polymeric blank, the method may include a first robot or second robot (e.g., first transfer robot 120 and second transfer robot 220) retrieving additional polymeric blanks and transferring them to available ovens of the individual oven banks.

If all of the ovens present in the APC are not occupied by a shuttle tray and polymeric blank, the method may still include a determination of whether a polymeric blank being heated has reached its working temperature (step 10070). For the purposes of this invention, a polymeric blank may be determined to have reached its working temperature by either testing the temperature of the polymeric blank with a sensor (e.g, a pyrometer) or by the polymeric blank having reached its heating time (e.g., 240 seconds). If a polymeric blank has reached its working temperature, a robot will retrieve the shuttle tray holding the polymeric blank and transfer the heated polymeric blank to a mechanical press of the APC for pressing (step 10080).

In addition, if all ovens present in the APC are heating a polymeric blank at step 10060, the method may still include a determination of whether one of the polymeric blanks has reached its working temperature. In the exemplary embodiment of system 1, if four polymeric blanks are present in the four ovens of the first and second oven banks (i.e., oven banks 130 and 230), the system may wait until one of the polymeric blanks has reached its working temperature. Additionally, a user may repeat steps 10030 and 10040 when all ovens of the oven banks are in use.

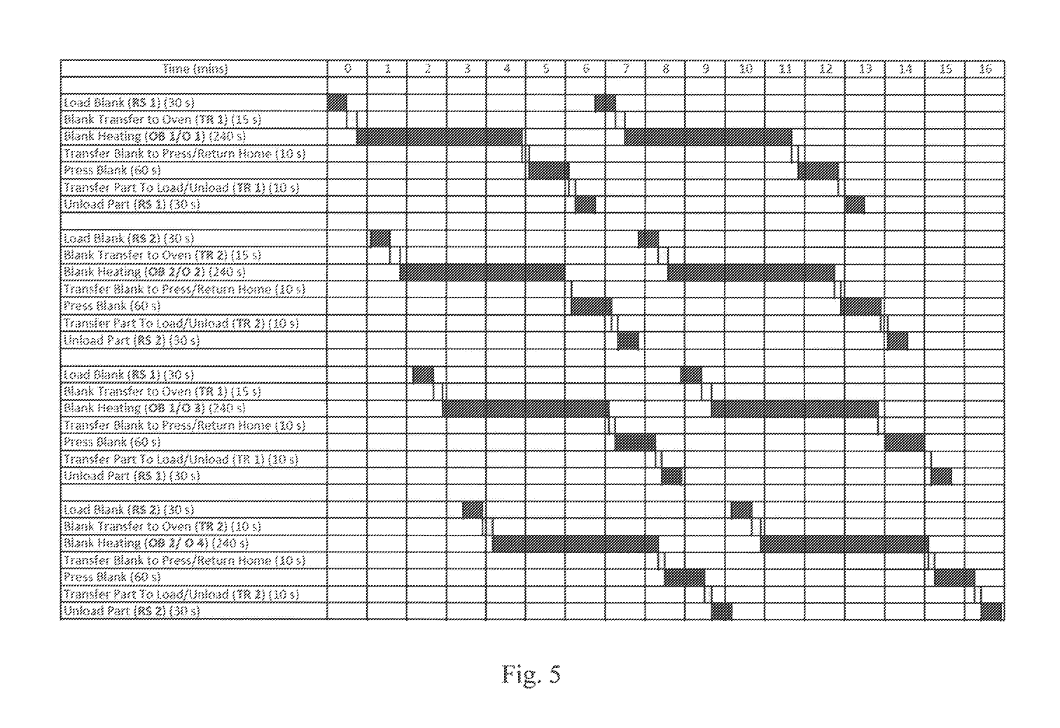

Alternatively, method 10000 may exclude steps 10060 and 10070 where the system is programmed such that each step is timed as shown, for example, in the exemplary method diagrammed in FIG. 5.

Moreover, if all of the ovens are not heating a polymeric blank at step 10060, and no polymeric blank being heated has reached its working temperature at step 10070, the method may include returning to step 10030 to prepare and mount an additional polymeric blank on a shuttle tray and repeating steps 10040 to 10070 until all available ovens are occupied or a polymeric blank being heated has reached its working temperature.

In an exemplary embodiment, it is understood that the APC 10 may include two receiver stations (e.g., first and second receiver stations 110 and 210). Therefore, the methods of the invention may include alternating between two receiver stations for the mounting of polymeric blanks on shuttle trays and placing of said shuttle trays at a receiver station (i.e., steps 10030 and 10040). Each of the two receiver stations may be serviced by one of two transfer robots, such as the first and second transfer robots 120 and 220, respectively.

At step 10080, when a heated polymeric blank is transferred to a mechanical press, the transfer time may be less than about 10 seconds. However, in preferred embodiments, the transfer time is about 5 seconds. The transfer time is kept at a minimum to ensure that there is little time for the heated polymeric blank to cool between heating and pressing.

After transferring the heated polymeric blank to the mechanical press, the robot may position the polymeric blank in the shuttle tray over a selected die that is placed in the mechanical press (step 10090). The robot may maintain its grip on the shuttle tray during pressing. Preferably, the robot not only maintains its grip on the shuttle tray during pressing, but orients or positions the shuttle tray and polymeric blank disposed thereon at the die to provide an orientation that will yield the selected formation in the formed polymeric material after pressing.

Indeed, by maintaining its grip on the shuttle tray throughout pressing, the use of a robot allows for almost infinite variability in the formation process as the robot may manipulate and lock the position of the shuttle tray with respect to the die. Moreover, this allows for a generic die and/or shuttle tray to be used, where the robot may allow for adjustments in positioning of the polymeric blank with respect to the die without relying upon a specific die or shuttle tray to orient the polymeric blank in the mechanical press.

Upon positioning the shuttle tray at the die in the mechanical press, the mechanical press may press the heated polymeric blank to produce a formed polymeric material (step 10100). During pressing, the mechanical press may apply a holding pressure to the polymeric blank of about 5 to about 100 bar. In certain embodiments, the holding pressure may be about 10 to 60 bar. Preferably, the holding pressure may about 30 bar or 40 bar.

With respect to certain specific parameters, where the polymeric blank includes a PPS-carbon fiber polymeric material, the heating time for the blank may be about 230 to 250 seconds, the working temperature may be about 330° C., and the holding pressure may be about 20 to 40 bar. Moreover, for PPS polymeric materials, the tool temperature (i.e., the temperature of the blank at the mechanical press) may be about 200° C. Where the polymeric blank includes a PEEK-carbon fiber polymeric material, the heating time for the blank may be about 230 to 250 seconds, the working temperature may be about 425° C., the holding pressure may be about 30 to 50 bar, and the tooling temperature may be about 240° C.

Additionally, the methods of the invention may include the additional step of applying a mold releasing agent to the die at the mechanical press before or after pressing step 10100. Preferably, the releasing agent may be robotically applied.

After pressing, the formed polymeric material may be robotically transferred to the receiver station (step 10110). Alternatively, the receiver station may include an input station and output station where the polymeric blank is initially retrieved from an input station and the formed polymeric material is deposited, after pressing, at the output station. The input and output stations may be at different locations in the APC. However, in preferred embodiments, the receiver station may be both the input and output station where a polymeric blank may be loaded and a formed polymeric material may be unloaded from the APC by a user. Accordingly, after being robotically transferred, the user may remove the formed polymeric material from the receiver station (step 10120).

A particularly preferred method of the invention is provided in FIG. 5, which recites the steps for transferring, heating, and pressing eight polymeric blanks in system 1 of FIG. 1. As shown therein, polymeric blanks are loaded and retrieved from load/unload platforms 111 and 211 of first and second receiver stations 110 (RS 1) and 210 (RS 2), respectively. In an alternating pattern, first and second transfer robots 120 (TR 1) and 220 (TR 2), deposit up to four of the polymeric blanks into ovens 131 (O 1), 132 (O 3), 231 (O 2), and 232 (O 4) of oven banks 130 (OB 1) and 230 (OB 2). After about 240 seconds, the heated polymeric blanks are each transferred within about 10 seconds to the mechanical press 300 to be formed on a die 310 over about 60 seconds. During this process, a user may then re-load the load/unload platform 111 or 211, as shown, to continue the cycle. Upon pressing, the first and second transfer robots 120 (TR 1) and 220 (TR 2) return the formed polymeric blanks to the load/unload platforms 111 or 211 of the first or second receiver stations 110 (RS 1) or 210 (RS 2), respectively. The process for forming eight polymeric materials may have a duration of about 16 minutes.

After the fourth polymeric material is formed, a mold release robot 400 may spray mold releasing agent on the die 310 of the mechanical press 300.

By utilizing the foregoing process and systems, the present invention maximizes the efficiency of the four ovens and integrated mechanical press in the APC. For example, FIG. 5 provides an exemplary method that may be used with system 1 to provide a forming cycle that allows a user to rapidly form components from composite materials while having little to no downtime between the ovens and the associated mechanical press. In addition, the use of robots to transfer and position the shuttle trays during the process allows for almost infinite forming variability with more generic dies where the robot may position, and hold, a heated polymeric material at the die.

Additionally, the present methods of the invention may be embodied as a computer implemented process or processes and/or apparatus for performing such computer-implemented process or processes, and can also be embodied in the form of a tangible storage medium containing a computer program or other machine-readable instructions (herein “computer program”), wherein when the computer program is loaded into a computer or other processor (herein “computer”) and/or is executed by the computer, the computer becomes an apparatus for practicing the process or processes. Storage media for containing such computer program include, for example, floppy disks and diskettes, compact disk (CD)-ROMs (whether or not writeable), DVD digital disks, RAM and ROM memories, computer hard drives and back-up drives, external hard drives, “thumb” drives, and any other storage medium readable by a computer. The process or processes can also be embodied in the form of a computer program, for example, whether stored in a storage medium or transmitted over a transmission medium such as electrical conductors, fiber optics or other light conductors, or by electromagnetic radiation, wherein when the computer program is loaded into a computer and/or is executed by the computer, the computer becomes an apparatus for practicing the process or processes (e.g., control system 500). The process or processes may be implemented on a general purpose microprocessor or on a digital processor specifically configured to practice the process or processes. When a general-purpose microprocessor is employed, the computer program code configures the circuitry of the microprocessor to create specific logic circuit arrangements. Storage medium readable by a computer includes medium being readable by a computer per se or by another machine that reads the computer instructions for providing those instructions to a computer for controlling its operation. Such machines may include, for example, a punched card reader, a magnetic tape reader, a magnetic card reader, a memory card reader, an optical scanner, as well as machines for reading the storage media mentioned above.

A number of patent and non-patent publications may be cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

Moreover, as used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All systems and methods described herein that embody the present invention can, in alternate embodiments, be more specifically defined by any of the transitional terms “comprising,” “consisting essentially of,” and “consisting of.”

What is claimed is:

1. An automated system for forming a polymeric blank comprising:
a. an automated forming cell, comprising:
i. a receiver station configured to admit the polymeric blank into the forming cell;
ii. at least two oven banks that receive the polymeric blank from the receiver station, wherein the at least two oven banks comprise a plurality of ovens configured to heat the polymeric blank to a working temperature;
iii. a mechanical press that receives the polymeric blank from the at least two oven banks and presses the polymeric blank into a form; and
iv. at least two transfer robots disposed within the forming cell and configured to transfer the polymeric blank between two or more of the group consisting of the receiver station, the at least two oven banks, and the mechanical press; and
b. a control system communicatively coupled to the automated forming cell and configured to operate one or more of the group consisting of the receiver station, the at least two oven banks, the mechanical press, and the at least two transfer robots.

2. The automated system of claim 1, wherein the system comprises a plurality of automated forming cells.

3. The automated system of claim 1, wherein the receiver station comprises a first receiver station and a second receiver station.

4. The automated system of claim 1, wherein the receiver station comprises an input station and an output station.

5. The automated system of claim 1, wherein the at least two oven banks comprise a first oven bank and a second oven bank.

6. The automated system of claim 5, wherein each of the first and second oven banks comprises two ovens.

7. The automated system of claim 5, wherein each of the first and second oven banks comprises two IR ovens.

8. The automated system of claim 1, wherein the mechanical press comprises a hydraulic press.

9. The automated system of claim 1, wherein the mechanical press comprises a die.

10. The automated system of claim 1, wherein the mechanical press is configured to provide a working part pressure of about 5 bar to 100 bar.

11. The automated system of claim 1, wherein the at least two transfer robots comprise a first robot and a second robot.

12. The automated system of claim 11, wherein the at least two oven banks comprise first and second oven banks and the first and second robots are configured to transfer the polymeric blank to the first and second oven banks, respectively, from the receiver station.

13. The automated system of claim 11, wherein the first and second robot comprise first and second robot arms, respectively.

14. The automated system of claim 1, wherein the receiver station comprises a shuttle tray upon which the polymeric blank may be placed.

15. The automated system of claim 14, wherein the at least two robots are configured to transfer the polymeric blank between two or more of the group consisting of the receiver station, the at least two oven banks, and the mechanical press, using the shuttle tray.

16. The automated system of claim 14, wherein the at least two robots comprise an IR camera that is configured to detect the presence of the polymer blank on the shuttle tray.

17. The automated system of claim 14, where the at least two robots are configured to support and position the shuttle tray in the mechanical press when the mechanical press presses the polymeric blank into the form.

18. The automated system of claim 1, wherein the polymeric blank comprises a polymeric material selected from the group consisting of polyphenylene sulfide (PPS), polyether imide (PEI), polyetheretherketone (PEEK), polyetherketoneketone (PEKK), and a combination thereof.

19. The automated system of claim 18, wherein the polymeric blank comprises a fibrous material selected from the group consisting of Kevlar, carbon fiber, fiberglass, an a combination thereof.

20. The automated system of claim 1, wherein the polymeric blank comprises a reinforced thermoplastic laminate material.

21. The automated system of claim 20, wherein the reinforced thermoplastic laminate material comprises a weaved fabric, a UD tape, a chop fiber, or a combination thereof.

22. The automated system of claim 1, wherein the polymeric blank comprises a reinforced thermoplastic non-laminated material.

23. The automated system of claim 22, wherein the reinforced thermoplastic non-laminated material comprises a weaved fabric, a UD tape, a chop fiber, or a combination thereof.

24. The automated system of claim 1, comprising an applicator robot configured to apply a mold releasing agent to the mechanical press.

25. An automated method for forming a polymeric blank into a formed polymeric material with the system of claim 1, the method comprising the steps of:
a. receiving the polymeric blank at a receiver station of an automated forming cell;
b. robotically transferring the polymeric blank from the receiver station to one of at least two oven banks and heating the polymeric blank to a working temperature;
c. robotically transferring the heated polymeric blank to a mechanical press and pressing the heated polymeric blank into a formed polymeric material; and
d. robotically transferring the formed polymeric material to the receiver station of the automated forming cell.

26. The method of claim 25, wherein the working temperature is about 150° C. to about 550° C.

27. The method of claim 26, wherein the working temperature is about 300° C. to about 450° C.

28. The method of claim 25, wherein the step of pressing the heated polymeric blank comprises applying a holding pressure to the polymeric blank of about 5 bar to about 100 bar.

29. The method of claim 28, wherein the holding pressure is about 10 bar to about 60 bar.

30. The method of claim 29, wherein the holding pressure is about 30 bar.

31. The method of claim 29, wherein the holding pressure is about 40 bar.

32. The method of claim 25, wherein the step of robotically transferring the heated polymeric blank to the mechanical press comprises a transfer time of less than about 10 seconds.

33. The method of claim 32, wherein the transfer time is less than about 5 seconds.

34. The method of claim 25, wherein the step of heating the polymeric blank to a working temperature comprises a heating time of about 150 to about 330 seconds.

35. The method of claim 25, wherein the heating time is about 240 seconds.

36. The method of claim 25, wherein the polymeric blank comprises a polymeric material selected from the group consisting of polyphenylene sulfide (PPS), polyether imide (PEI), polyetheretherketone (PEEK), polyetherketoneketone (PEKK), and a combination thereof.

37. The method of claim 36, wherein the polymeric blank comprises a fibrous material selected from the group consisting of Kevlar, carbon fiber, fiberglass, and a combination thereof.

38. The method of claim 25, wherein the polymeric blank comprises a reinforced thermoplastic laminate material.

39. The method of claim 38, wherein the reinforced thermoplastic laminate material comprises a weaved fabric, a UD tape, a chop fiber, or a combination thereof.

40. The method of claim 25, wherein the polymeric blank comprises a reinforced thermoplastic non-laminated material.

41. The method of claim 40, wherein the reinforced thermoplastic non-laminated material comprises a weaved fabric, a UD tape, a chop fiber, or a combination thereof.

42. The method of claim 25, wherein the at least two oven banks comprise a first oven bank and a second oven bank.

43. The method of claim 42, wherein each of the first and second oven banks comprise two ovens.

44. The method of claim 42, wherein the method comprises:
i. robotically transferring a first polymeric blank to the first oven bank and heating the first polymeric blank to a working temperature, and then
ii. robotically transferring a second polymeric blank to the second oven bank and heating the second polymeric blank a working temperature.

45. The method of claim 44, wherein the method comprises:
i. robotically transferring a third polymeric blank to the first oven bank and heating the third polymeric blank to a working temperature.

46. The method of claim 45, wherein the method comprises:
i. robotically transferring the first heated polymeric blank from the first oven bank to the mechanical press before the second polymeric blank has finished heating and pressing the first heated polymeric blank into a first formed polymeric material;
ii. removing the first formed polymeric material from the mechanical press; and
iii. robotically transferring the second heated polymeric blank from the second oven bank to the mechanical press before the third polymeric blank has finished heating and pressing the second heated polymeric blank into a second formed polymeric material.

47. The method of claim 46, wherein the method comprises:
i. robotically transferring a fourth polymeric blank to the second oven bank and heating the fourth polymeric blank to a working temperature.
ii. removing the second formed polymeric material from the mechanical press; and
iii. robotically transferring the third heated polymeric blank from the first oven bank to the mechanical press before the fourth polymeric blank has finished heating and pressing the third heated polymeric blank into a third formed polymeric material.

48. The method of claim 25, comprising the step of applying a mold releasing agent to the mechanical press.

49. The method of claim 25, wherein the step of applying a mold releasing agent to the mechanical press comprises applying the mold releasing agent to a die that is located within the mechanical press.

50. The method of claim 25, comprising repeating steps a through d.

51. The method of claim 25, wherein the step of robotically transferring the heated polymeric blank to the mechanical press and pressing the heated polymeric blank comprises robotically supporting the heated polymeric blank during pressing.

52. The method of claim 51, wherein robotically supporting the heated polymer blank during pressing comprises positioning the heated polymeric blank on a die disposed within the mechanical during pressing.
